(19) United States
(12) Patent Application Publication
(10) Pub. No.: US 2011/0274612 A1
(43) Pub. Date: Nov. 10, 2011

(54) LIGNIN DERIVATIVE, SHAPED BODY COMPRISING THE DERIVATIVE AND CARBON FIBERS PRODUCED FROM THE SHAPED BODY

(75) Inventors: Bernd Wohlmann, Dusseldorf (DE); Michael Wolki, Dusseldorf (DE); Andreas Ebert, Schwielowsee (DE); Gunnar Engelmann, Potsdam (DE); Hans-Peter Fink, Teltow (DE)

(73) Assignees: FRAUNHOFER GESEIISCHAFT ZUR FORDERUNG DER ANGEWANDTEN FORSCHUNG E.V., Munich (DE); TOHO TENAX EUROPE GMBH, Wuppertal (DE)

(21) Appl. No.: 13/144,879

(22) PCT Filed: Jan. 11, 2010
(86) PCT No.: PCT/EP2010/050185

§ 371 Date: Jul. 15, 2011

(30) Foreign Application Priority Data
Jan. 15, 2009 (EP) 09150619.6

(51) Int. Cl. D01F 9/12; C08H 7/00

(52) U.S. Cl. 423/447.2; 530/500

(57) ABSTRACT

A lignin derivative is produced from a lignin with the empirical formula L(OH)_{z}, where L is a lignin without hydroxyl groups, OH are free hydroxyl groups bonded to L, and z is 100% of the free hydroxyl groups bonded to L. The lignin derivative has free hydroxyl groups that are derivatized with divalent residues Rₓ and monovalent residues R_{y} that are bonded to L via an ester, ether, or urethane group. A shaped body comprising the lignin derivative can take the form of a fiber, e.g. as precursor fiber for the production of a carbon fiber. A carbon fiber can be produced from the above-mentioned precursor fiber.

### BACKGROUND

The present invention relates to a lignin derivative, shaped bodies comprising the derivative, and carbon fibers produced from the shaped body.

U.S. Pat. No 3,519,581 describes a method in which lignin dissolved in a solvent is reacted with an organic polyisocyanate. Due to the polyisocyanate contained in the resulting lignin derivative, the lignin derivative described in U.S. Pat. No. 3,519,581 has a thermoset characteristic.

The object of the present invention is therefore to provide a thermoplastically processable, filament-forming lignin derivative.

### BRIEF DESCRIPTION OF DRAWING

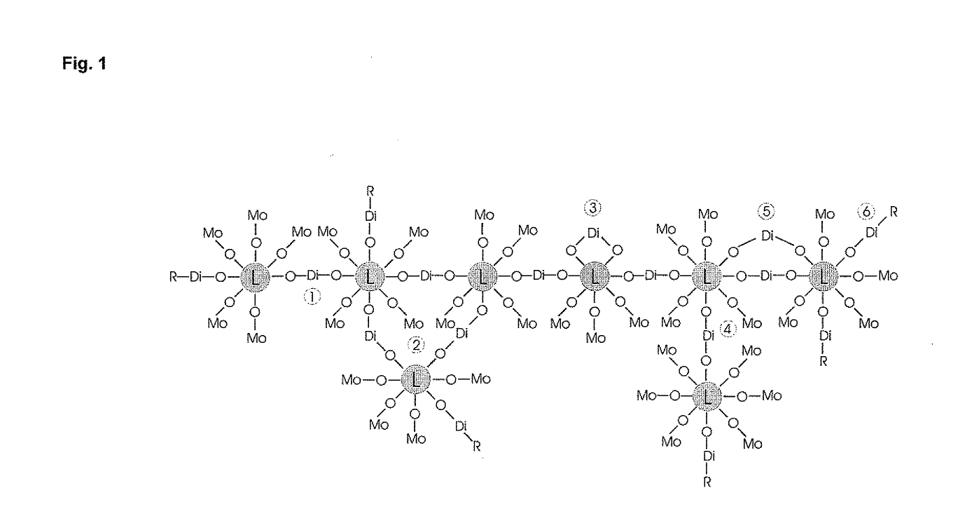

The lignin derivative may have the structure shown schematically in FIG. 1.

### DETAILED DESCRIPTION OF EMBODIMENTS

A lignin derivative may be produced from a lignin with the empirical formula (1):

L(OH)_{z} (1),

where L is a lignin without hydroxyl groups, OH are the free hydroxyl groups bonded to L, and z is 100% of the free hydroxyl groups bonded to L. In that in the lignin derivative x≧0.1% of the free hydroxyl groups bonded to L are derivatized with divalent residues Rₓ that are bonded to L via an ester, ether, or urethane group, y≧0.1% of the free hydroxyl groups bonded to L are derivatized with monovalent residues R_{y} that are bonded to L via an ester, ether, or urethane group, x+y=100%, and z=0%.

With respect to the hydroxyl groups of the lignin from which it was produced, a lignin derivative is thus completely derivatized with monovalent and divalent residues. This means that in the infrared spectrum, the typical lignin OH bands in the range from approximately 3000 cm⁻¹ to approximately 3500 cm⁻¹ are no longer detectable within the context of the measuring precision.

In a lignin derivative, the chemical form of the bond between the divalent residues and L is independent of the chemical form of the bond between the monovalent residues and L. This means that if the divalent residues are bonded to L via ester groups, the monovalent residues may be bonded to L also via ester groups or via ether groups or urethane groups, if the divalent residues are bonded to L via ether groups, the monovalent residues may be bonded to L also via ether groups or via ester groups or urethane groups, and if the divalent residues are bonded to L via a urethane group, the monovalent residues may be bonded to L also via urethane groups or via ester groups or ether groups.

The lignin derivative may be processed thermoplastically and form filaments. Furthermore, in some embodiments such as in those in which the divalent residues Rₓ are derived from an oligomer, such as an oligoester or an oligourethane and which are described in further detail below, the lignin derivative may be partially elastic.

The lignin derivative may have a glass transition temperature T_{g} in the range from −30° C. to 200° C., or in the range from −10° C. to 170° C.

The lignin derivative may have a weight-average molecular weight of at least 10,000 g/mol or at least 20,000 g/mol. The lignin derivative may have an upper limit molecular weight in a range from approximately 80,000 g/mol to approximately 150,000 g/mol.

X may be in the range from 1% to 99% and y may be in the range from 99% to 1%, x may be in the range from 10% to 90% and y may be in the range from 90% to 10%, or x may be in the range from 20% to 80% and y may be in the range from 80% to 20%, but in all cases x+y=100%.

The divalent residues Rₓ may be derived from a compound that possesses two functional groups, both of which may be predominantly bonded to L via an ester, ether, or urethane group to form a lignin derivative. The two functional groups may be end groups, that means groups which are bonded in an α,ω-position to the compound from which the divalent residues Rₓ are derived from.

The divalent residues Rₓ may be derived from a compound that possesses two identical functional groups, both of which may predominantly be bonded to L via an ester, ether, or urethane group to folia the lignin derivative. The term “predominantly” means that more than 50% of the two identical functional groups are bonded to L via an ester, ether, or urethane group. Furthermore, the two identical functional groups may be end groups, that means groups which are bonded in an α,ω-position to the compound from which the divalent residues Rₓ are derived from.

At least 20% or at least 60% of the two identical functional groups are bonded to L via an ester, ether, or urethane group. Thereby the two identical functional groups may be end groups, that means groups which may be bonded in an α,ω-position to the compound from which the divalent residues Rₓ are derived from.

The divalent residues Rₓ may be from a dicarboxylic acid or an activated dicarboxylic acid, such as from a dicarboxylic acid chloride in which at least one carboxylic acid group or at least one carboxylic acid chloride group of the dicarboxylic acid or dicarboxylic acid chloride is bonded to L via an ester group. Both activated carboxylic acid groups or both carboxylic acid chloride groups of the dicarboxylic acid or dicarboxylic acid chloride may be bonded to L via both ester groups. The dicarboxylic acid may hereby be selected from the group consisting of saturated aliphatic dicarboxylic acids with the general formula HOOC—(CH₂)ₙ—COOH, where n may have values in the range from 1 to 20 and any value between 1 and 20, unsaturated aliphatic dicarboxylic acids, aliphatic carboxylic acids with aliphatic and/or aromatic side groups, and aromatic dicarboxylic acids such as phenylene dicarboxylic acids.

The divalent residues Rₓ may be derived from an oligoester with two activated carboxylic acid end groups, with at least one carboxylic acid end group of the oligoester being bonded to L via an ester group. Both activated carboxylic acid end groups of the oligoester may each be bonded to L via an ester group. The oligoester may thereby be produced by condensation of aliphatic dicarboxylic acids with aliphatic diols, aromatic dicarboxylic acids with aliphatic diols, aliphatic dicarboxylic acids with aromatic diols, or aromatic dicarboxylic acids with aromatic diols. Furthermore, mixtures of aliphatic and aromatic representatives of the above monomer types may be employed for the production of the oligoester. A condensate may be produced from an aliphatic or aromatic dicarboxylic acid with aliphatic diols employed. Saturated and unsaturated α,ω diols with 2-18 carbon atoms or aromatic diols such as hydroquinone or 4,4′-dihydroxy,1,1′-biphenyl may be used as diols for the oligoester. Branched diols may also be employed for the production of the oligoester. Oligodiols or polyester diols as well as oligoether diols or polyether diols may also be employed as diols. The above-mentioned dicarboxylic acids may be employed as dicarboxylic acid. The molar ratio of dicarboxylic acid to diol in the oligoester may be in the range from 1 to 2, or in the range from 1.1 to 1.9.

The divalent residues Rₓ may be from a diisocyanate with at least one isocyanate group of the diisocyanate being bonded to L via a urethane group. Both isocyanate groups of the diisocyanate may be to L via a urethane group. The diisocyanate acid may be selected from the group consisting of saturated aliphatic diisocyanates with the general formula O═C═N—(CH₂)ₙ—N═C═0, where n may have values in the range from 2 to 18 and any value between 2 and 18, branched diisocyanates, cyclic saturated, or partially unsaturated diisocyanates, such as isophoron diisocyanate, and aromatic diisocyanates such as TDI (i.e. 2,4-toluene diisocyanate) or MDT (i.e. 4,4′-methylene-bis-(phenylisocyanate)). The isocyanate groups may also have protective groups, such as protective groups from the group of aliphatic or aromatic alcohols, amides, or thiols.

The divalent residues Rₓ may be derived from an oligourethane with two isocyanate end groups, where at least one isocyanate end group of the oligourethane is bonded to L via a urethane group. The above-mentioned diisocyanates and diols may thereby be employed for the production of the oligourethane. The molar ratio of diisocyanate to diol may be in the range from 1 to 2, or in the range from 1.1 to 1.9.

The monovalent residues R_{y} may be derived from an activated monocarboxylic acid, such as from a monocarboxylic acid chloride or from a monoisocyanate, with the activated monocarboxylic acid being bonded to L via an ester group or the monoisocyanate being bonded to L via a urethane group and in which the activated monocarboxylic acid may also be employed as an acid anhydride. The monocarboxylic acid may hereby be selected from the group consisting of linear saturated aliphatic monocarboxylic acids with the general formula CH₃—(CH₂)ₙ—COOH, where n may have values in the range from 0 to 21 and any value between 0 and 21, branched saturated aliphatic carboxylic acids in which the branching may be effected e.g. by an i-propyl, i-butyl, or tert.-butyl group, and unsaturated aliphatic monocarboxylic acids, such as monocarboxylic acids with one or more double bonds in the aliphatic residue, such as acrylic acid, methacrylic acid or crotonic acid, monocarboxylic acids with an aromatic or araliphatic residue that may consist of one or more rings, in which the ring size per ring may be between 4 and 8 ring atoms, where the ring atoms may either be exclusively C atoms or C atoms in combination with hereroatoms such as O, S, N, and P, and where the rings may be joined together by single, double, or triple bonds, or may exist in annelated form or in both bond forms such as phenyl, cinnamate, (1,2)-naphthyl, anthracenyl, phenantryl, biphenyl, terphenyl, bithiophenyl, terthiophenyl, bipyrrolyl, or terpyrrolyl, etc. Mixtures of the above monocarboxylic acids or monoisocyanates may also be used as monovalent residues R_{y}. The same applies by analogy for the residue of the above monoisocyanates as for the residue of the above monocarboxylic acids.

Lignins of any origin may be used for the production of the lignin derivative, such as lignins from deciduous and coniferous trees and from annual plants. These lignins may be derived by means of pulping processes in which the lignin may either be extracted from the wood using organic solvents, during the course of which a catalyst may be employed, such as in the Organosolv process, or may be separated completely or partially from the cellulose by treating wood under alkaline or acid conditions, such as in the industrially employed kraft process.

To manufacture the lignin derivative pure lignin may be used. The term “pure lignin” means that the lignin used to manufacture the lignin derivative may contain at most 5 percent by weight, at most 1 percent by weight, or at most 0.5 percent by weight of components like cellulose, hemicellulose, or inorganic salts. Consequently, the lignin derivative may be manufactured from a lignin exhibiting a degree of purity of at least 95 percent by weight, at least 99 percent by weight, or even at least 99.5 percent by weight.

The lignin derivative may be produced by first derivatizing the respective selected lignin with the respective selected divalent residue Rₓ, with x % of the free hydroxyl groups bonded to L being bonded via an ester, ether, or urethane group to the divalent residue Rₓ, with the remaining y % of the free hydroxyl groups bonded to L then being derivatized with the respective selected monovalent residue R_{y}, so that y % of the free hydroxyl groups bonded to L may be bonded via an ester, ether, or urethane group to the monovalent residue Rₓ and z=0%.

Alternatively the lignin derivative may be produced by first derivatizing the respective selected lignin with the respective selected monovalent residue R_{y}, with y % of the free hydroxyl groups bonded to L being bonded via an ester, ether, or urethane group to the monovalent residue R_{y}, with the remaining x % of the free hydroxyl groups bonded to L then being derivatized with the respective selected divalent residue Rₓ, so that x % of the free hydroxyl groups bonded to L may be bonded via an ester, ether, or urethane group to the divalent residue R_{y} and z=0%.

The above-mentioned derivatization reactions result in a lignin derivative that may be catalytically accelerated. For example, the ester formation may be accelerated with 1-methylimidazole.

The resulting lignin derivative may have the structure shown schematically in FIG. 1, where L is the lignin without hydroxyl groups, O the oxygen atom that forms part of an ester, ether, or urethane bond via which the respective divalent residue Rₓ designated “Di” in FIG. 1 is bonded to L, and “Mo” is the respective monovalent residue R_{y} that is bonded to L via an oxygen atom O that forms part of an ester, ether, or urethane bond. In FIG. 1, 1 depicts a single linear linkage, 2 depicts a cross-linking, 3 depicts a loop formation, 4 depicts a branching (relative to the main chain), 5 depicts a double linear linkage, and 6 depicts a divalent unit that is bonded to L via O with only one of its end groups so that its second end group designated “R” is free.

As already mentioned, the lignin derivative may be processed thermoplastically. A shaped body comprising the lignin derivative may be produced by thermoplastic processing, such as kneading, extrusion, melt spinning, or injection molding of the lignin derivative in the range from 30° C. to 250° C. In the higher processing temperature range from approximately 150° C. to 250° C., processing of the lignin derivative to form the shaped body may be carried out under an inert gas atmosphere.

The shaped body may take the form of a fiber.

In an embodiment in which the fiber comprises a lignin derivative whose divalent residues Rₓ may be derived from an oligoester with two carboxylic acid end groups with at least one carboxylic acid end group of the oligoester being bonded to L via an ester group, or in a further embodiment in which the fiber comprises a lignin derivative whose divalent residues Rₓ may be derived from a diisocyanate with at least one isocyanate group of the diisocyanate being bonded to L via a urethane group, the fiber may be a precursor fiber for the production of a carbon fiber.

The shaped object may take the form of a film, such as a semi-permeable membrane. This membrane may be a battery separator.

Furthermore, a carbon fiber may be produced from the precursor fiber by the consecutive process steps of oxidation and carbonization which may be followed by a third process step of graphitization.

The process step of oxidation takes place under an oxidizing atmosphere, such as under air or ozone. The oxidation may take place in one or more stages, where the one oxidation stage or the several oxidation stages may be carried out in a temperature range from 150° C. to 400° C., or in a temperature range between 180° C. and 250° C. The rate of heating during the respective process stage(s) may be in the range from 0.1 K/min to 10 K/min, or in the range from 0.2 K/min to 5 K/min. The process step of oxidation transforms the thermoplastic precursor fiber into a non-thermoplastic fiber that may be referred to as a stabilized fiber.

The process step of carbonization of the stabilized fiber following the oxidation may be performed under an inert gas atmosphere, such as nitrogen. Carbonization may be performed in one or more stages. During carbonization the stabilized fiber may be heated at a rate of heating in the range from 10 K/s to 5 K/min, or in the range from 5 K/s to 5 K/min. The final temperature of the carbonization may have a value of up to 1800° C. The process step of carbonization transforms the stabilized fiber into a carbonized fiber, i.e. into a fiber whose fiber-forming may be carbon.

Following carbonization, the carbonized fiber may be further refined in the process step of graphitization. The graphitization may be performed in a single stage with the carbonized fiber being heated to a temperature of, for example, 3000° C. at a rate of heating of approximately 5 K/s to 5 K/min in an atmosphere consisting of a monoatomic inert gas, such as argon. The process step of graphitization transforms the carbonized fiber into a graphitized fiber. Stretching of the carbonized fiber during the graphitization results in a significant increase in the modulus of elasticity of the resulting graphitized fiber. Graphitization of the carbonized fiber may be performed with simultaneous stretching of the fiber.

The values of x and y are determined by ¹³C-NMR spectroscopy with the ¹³C signals being determined in a DMSO solution at 80° C.

The glass transition temperature T_{g} is determined by differential scanning calorimetry (DSC) with the values obtained in the second scan with a rate of heating of 10 K/min being used.

The weight-average molecular weight M_{w} and the number-average molecular weight Mₙ are determined by gel permeation chromatography (GPC) using dimethyl sulphoxide as solvent.

### EXAMPLES

The present invention is described in further detail by reference to the following Examples, which are in no way limiting.

### Example 1

10 g deciduous wood lignin exhibiting a degree of purity of 99.5 percent by weight are dried at 80° C. for 16 hours in a vacuum over P₄O₁₀. The dried lignin is dissolved in 50 ml absolute dimethyl acetamide and mixed with 3.935 g (38.89 mmol) triethylamine.

A second solution of 3.56 g (19.44 mmol) adipic acid dichloride in 20 ml absolute dimethyl acetamide is prepared separately and dropped slowly into the lignin solution described above under an inert gas atmosphere while stirring intensively with ice water cooling. After 10 minutes intensive mixing, an excess of propionic acid anhydride together with 0.5 g 1-methylimidazole is added. The mixture is then heated to 50° C. and the reaction formulation is stirred for 2 hours at this temperature. The formulation is then allowed to cool down to room temperature, the resulting viscous solution is added to approximately 500 ml ethanol, stirred for one hour and then filtered with the filtrate being checked for complete precipitation by dropping into water. This results in a filter cake that is boiled out in the heat three times each with 200 ml ethanol/water (9:1), that means purified at the boiling point of the ethanol/water-mixture, and then boiled out once with ethanol, that means purified at the boiling point of ethanol. After drying in air, the product is dried to constant weight under vacuum. 4.5 g lignin derivative A are weighed out. The lignin derivative A has a glass transition temperature T_{g} of 132° C., a weight-average molecular weight M_{w} of 10100 g/mol, a polydispersity P=M_{w}/Mₙ of 5.6 and a ratio of monovalent residue/divalent residue of 62%:38%. ¹³C-NMR-spectroscopy is used to determine, that 85 percent of the both functional end groups of the adipic acid dichloride is bonded to L via an ester bond.

### Example 2

10 g deciduous wood lignin exhibiting a degree of purity of 99.5 percent by weight are dried at 80° C. for 16 hours in a vacuum over P₄O₁₀. The dried lignin is dissolved in 50 ml absolute dimethyl acetamide and mixed with 7.308 g (72.22 mmol) triethylamine.

A second solution of 6.61 g (36.11 mmol) adipic acid dichloride in 20 ml absolute dimethyl acetamide is prepared separately and dropped slowly into the lignin solution described above under an inert gas atmosphere while stirring intensively with ice water cooling. After 10 minutes intensive mixing of the lignin solution with the adipic acid dichloride solution, an excess of propionic acid anhydride together with 0.5 g 1-methylimidazole is added. The mixture is then heated to 50° C. and the reaction formulation is stirred for 2 hours at this temperature. The formulation is then allowed to cool down to room temperature, the resulting viscous solution is added to approximately 500 ml ethanol, stirred for one hour and then filtered with the filtrate being checked for complete precipitation by dropping into water. This results in a filter cake that is boiled out in the heat three times each with 200 ml ethanol/water (9:1), that means purified at the boiling point of the ethanol/water-mixture and then boiled out once with ethanol, that means purified at the boiling point of ethanol. After drying in air, the product is dried to constant weight under vacuum. 9.3 g lignin derivative B are weighed out. The lignin derivative B has a glass transition temperature T_{g} of 133° C., a weight-average molecular weight M_{w} of 18200 g/mol, a polydispersity P of 10 and a ratio of monovalent residue/divalent residue of 48%:52%. ¹³C-NMR-spectroscopy is used to determine, that 83 percent of the both functional end groups of the adipic acid dichloride is bonded to L via an ester bond.

### Example 3

10 g deciduous wood lignin exhibiting a degree of purity of 99.5 percent by weight are dried at 80° C. for 16 hours in a vacuum over P₄O₁₀. The dried lignin is dissolved in 50 ml absolute dimethyl acetamide and mixed with 7.308 g (72.22 mmol) triethylamine. This results in a solution 1.

A second solution is prepared separately as follows: 13.219 g (72.22 mmol) adipic acid dichloride are dissolved in 75 ml absolute dimethyl acetamide. A solution of 2.748 g (36.11 mmol) anhydrous 1,3-propanediol in 10 ml absolute dimethyl acetamide is dropped into this solution under inert gas atmosphere, ice water cooling and intensive stirring. A solution of 7.308 g (72.22 mmol) triethylamine in 20 ml absolute dimethyl acetamide is then dropped in while stirring intensively and subsequently stirred for 10 minutes at room temperature. This results in a solution 2.

Solution 1 is then quickly poured into solution 2 and the resulting mixture stirred intensively.

After 10 minutes intensive mixing of solution 1 with solution 2, an excess of propionic acid anhydride together with 0.5 g 1-methylimidazole is added. The mixture is then heated to 50° C. and the reaction formulation is stirred for 2 hours at this temperature. The formulation is then allowed to cool down to room temperature, the resulting viscous solution is added to approximately 500 ml ethanol, stirred for one hour and then filtered with the filtrate being checked for complete precipitation by dropping into water. This results in a filter cake that is boiled out in the heat three times each with 200 ml ethanol/water (9:1), that means purified at the boiling point of the ethanol/water-mixture and then boiled out once with ethanol, that means purified at the boiling point of ethanol. After drying in air, the product is dried to constant weight under vacuum. 9.7 g lignin derivative C are weighed out. The lignin derivative C has a very weakly marked glass transition point, a weight-average molecular weight M_{w} of 20600 g/mol, a polydispersity P of 11 and a ratio of monovalent residue/divalent residue of 50%:50%. The adipate/propanediolate ratio determined by ¹³C-NMR spectroscopy is 1.7:1.

### Example 4

10 g deciduous wood lignin exhibiting a degree of purity of 99.5 percent by weight are dried at 80° C. for 16 hours in a vacuum over P₄O₁₀. The dried lignin is dissolved in 50 ml absolute dimethyl acetamide and mixed with 7.308 g (72.22 mmol) triethylamine. This results in a solution 1.

A second solution is prepared separately as follows: 19.828 g (108.33 mmol) adipic acid dichloride are dissolved in 75 ml absolute dimethyl acetamide. A solution of 5.495 g (72.22 mmol) anhydrous 1,3-propanediol in 10 ml absolute dimethyl acetamide is dropped into this solution under inert gas atmosphere, ice water cooling and intensive stirring. A solution of 14.616 g (144.44 mmol) triethylamine in 20 ml absolute dimethyl acetamide is then dropped in while stirring intensively and subsequently stirred for 10 minutes at room temperature. This results in a solution 2.

Solution 1 is then quickly poured into solution 2 and the resulting mixture stirred intensively.

After 10 minutes intensive mixing of solution 1 with solution 2, an excess of propionic acid anhydride together with 0.5 g 1-methylimidazole is added. The mixture is then heated to 50° C. and the reaction formulation is stirred for 2 hours at this temperature. The formulation is then allowed to cool down to room temperature, the resulting viscous solution is added to approximately 500 ml ethanol, stirred for one hour and subsequently filtered with the filtrate being checked for complete precipitation by dropping into water. This results in a filter cake that is boiled out in the heat three times each with 200 ml ethanol/water (9:1), that means purified at the boiling point of the ethanol/water-mixture and then boiled out once with ethanol, that means purified at the boiling point of ethanol. After drying in air, the product is dried to constant weight under vacuum. 12.3 g lignin derivative D are weighed out. The lignin derivative D has a very weakly marked glass transition point, a weight-average molecular weight M_{w} of 42500 g/mol, a polydispersity P of 15 and a ratio of monovalent residue/divalent residue of 47%:53%. The adipate/propanediolate ratio determined by ¹³C-NMR spectroscopy is 1.39:1.

### Example 5

A lignin derivative E is produced in a similar way to that described in Examples 3 and 4. The lignin derivative E has a very weakly marked glass transition point, an average molecular weight M_{w} of 36250 g/mol, a polydispersity P of 21.5 and a ratio of monovalent residue/divalent residue of 61%:39%. The adipate/propanediolate ratio determined by ¹³C-NMR spectroscopy is 1.35:1.

The lignin derivative E is spun on a laboratory twin-screw extruder at 110° C. and with a screw speed of 170 min⁻¹ through a single-hole die with a hole diameter of 500 μm to produce a monofilament with a diameter of 250 μm and this monofilament is then wound up without breaking. The monofilament has a smooth surface and a smooth cross-section after breaking at low temperature. Thereby the term “tracking at low temperature” means, that the monofilament is dipped into liquid nitrogen and subsequently broken.

The monofilament is suitable as a precursor fiber for the production of a carbon fiber, as shown in the following examples.

### Example 6

The thermoplastic monofilament from Example 5 is transformed into a non-thermoplastic monofilament by thermal oxidation. For this the thermoplastic monofilament is mounted on a ceramic plate with the ends of the monofilament being fixed to the ceramic plate with high-temperature-resistant ceramic cement. The monofilament is then heated in a kiln under an air atmosphere at a rate of heating of 0.2 K/min up to a temperature of 180° C. and the monofilament is held at this temperature for 12 hours. The kiln is then allowed to cool down to room temperature by switching off the heating. This results in a non-thermoplastic stabilized monofilament.

### Example 7

The stabilized monofilament from Example 6 is mounted on a ceramic plate with the ends of the monofilament being fixed to the ceramic plate with high-temperature-resistant ceramic cement. The monofilament is then heated at a rate of heating of 3 K/min up to a temperature of 1100° C. and held for 30 minutes at this temperature. The kiln is then allowed to cool down to room temperature by switching off the heating. This results in a carbonized monofilament.

1. A lignin derivative produced from a lignin having an empirical formula (1):
L(OH)_{z} (1),
wherein L is a lignin without hydroxyl groups,
OH are free hydroxyl groups bonded to L,
z is 100% of the free hydroxyl groups bonded to L,
wherein the lignin derivative satisfies the following:
x≧0.1% of the free hydroxyl groups bonded to L are derivatized with divalent residues Rₓ that are bonded to L via an ester, ether, or urethane group;
y≧0.1% of the free hydroxyl groups bonded to L are derivatized with monovalent residues R_{y} that are bonded to L via an ester, ether, or urethane group;
x+y=100%; and
z=0%.

2. The lignin derivative according to claim 1, wherein the lignin derivative has a glass transition temperature T_{g} in the range from −30° C. to 200° C.

3. The lignin derivative according to claim 1, wherein the lignin derivative has a weight-average molecular weight M_{w} of at least 10,000 g/mol.

4. The lignin derivative according to claim 1, wherein x is in the range from 1% to 99% and y is in the range from 99% to 1%.

5. The lignin derivative according to claim 1, wherein the divalent residues Rₓ are derived from a compound which comprises two identical functional groups, both of which are predominantly bonded to L via an ester, ether, or urethane group to form the lignin derivative.

6. The lignin derivative according to claim 5, wherein at least 20% of the two identical functional groups are bonded to L via an ester, ether, or urethane group.

7. The lignin derivative according to claim 1, wherein the divalent residues Rₓ are derived from a dicarboxylic acid or a dicarboxylic acid chloride in which at least one carboxylic acid group or at least one carboxylic acid chloride group of the dicarboxylic acid or dicarboxylic acid chloride is bonded to L via an ester group.

8. The lignin derivative according to claim 1, wherein the divalent residues Rₓ are derived from an oligoester with two carboxylic acid end groups, with at least one carboxylic acid end group of the oligoester being bonded to L via an ester group.

9. The lignin derivative according to claim 1, wherein the divalent residues Rₓ are derived from a diisocyanate with at least one isocyanate group of the diisocyanate being bonded to L via a urethane group.

10. The lignin derivative according to claim 1, wherein the divalent residues Rₓ are derived from an oligourethane with two isocyanate end groups, with at least one isocyanate end group of the oligourethane being bonded to L via a urethane group.

11. The lignin derivative according to claim 1, wherein the monovalent residues R_{y} are derived from a monocarboxylic acid or a monoisocyanate, with the monocarboxylic acid being bonded to L via an ester group or the monoisocyanate being bonded to L via a urethane group.

12. A shaped body comprising the lignin derivative according to claim 1.

13. The shaped body according to claim 12, wherein the shaped body takes the form of a fiber.

14. The shaped body according to claim 13, wherein the fiber is a precursor fiber for the production of a carbon fiber.

15. The shaped body according to claim 12, wherein the shaped body takes the form of a membrane.

16. The shaped body according to claim 15, wherein the membrane is a battery separator.

17. Carbon fiber is produced from the precursor fiber according to claim 14.
